(19) United States
(12) Patent Application Publication
(10) Pub. No.: US 2005/0099275 A1
(43) Pub. Date: May 12, 2005

(54) Method and system for status indication on a key fob

(76) Inventors: Hitan S. Kamdar, Utica, MI (US); Eric J. Schuh, Burton, MI (US)

Correspondence Address: ANTHONY LUKE SIMON, ESQ.;GENERAL MOTORS CORPORATION, LEGAL STAFF, MAIL CODE: 482-C23-B21, 300 RENAISSANCE CENTER, DETROIT, MI, 48265, US

(21) Appl. No.: 10/704,201

(22) Filed: Nov. 6, 2003

(51) Int. Cl. B60Q 1/00

(52) U.S. Cl. 340/426.18; 340/426.16

(57) ABSTRACT

The invention provides a system for determining a vehicle security status and providing the status to the vehicle driver using a key fob wirelessly connected to a telematics unit located within the vehicle. A method for providing security status includes providing a key fob in wireless communication with a vehicle, the key fob including a status indicator, receiving sensor signals of vehicle components positions at the vehicle telematics unit determining whether the vehicle components positions are in an unsecured status position, sending a notification signal based on the determination from the vehicle telematics unit to the key fob and activating the status indicator of the key fob based on the notification.

### FIELD OF THE INVENTION

This invention relates generally to data transmissions over a wireless communication system. More specifically, the invention relates to a wireless key system that includes a key fob device for receiving vehicle status indicators.

### BACKGROUND OF THE INVENTION

Wireless communication services for mobile vehicles, such as navigation and roadside assistance, have increased rapidly in recent years and are expanding into new service areas. Most available telematics services apply to a motor vehicle in operation, but more recently, the demands and potential for communication, networking and diagnostic services have grown. Currently, the user who is outside the vehicle can control a few vehicle and telematics functions, such as unlocking a door and setting or disabling a car alarm, with a wireless key or remote.

Wireless keys or remotes offer a level of convenience for vehicle users, enabling them to perform these and other functions from a distance. However, unless the user determines that the door is locked or the alarm is turned on before he steps away from the vehicle, he cannot be absolutely sure that the car is secured.

It is an object of this invention, therefore, to provide a system, device, and method to provide vehicle security status to the vehicle user that overcomes these and other deficiencies.

### SUMMARY OF THE INVENTION

One aspect of the invention provides a method for notifying a vehicle user of an unsecured vehicle. The method includes steps for providing a key fob in wireless communication with a vehicle, the key fob including a status indicator, receiving sensor signals of vehicle components positions at the vehicle telematics unit and determining whether the vehicle components positions are in an unsecured status position. Then based on the determination that the vehicle is not secure, sending a notification signal from the vehicle telematics unit to the key fob; and activating the status indicator of the key fob based on the notification.

Another aspect of the invention provides a computer usable medium including a program for communicating vehicle security status between a mobile vehicle and a key fob. The program includes computer readable code for receiving sensor signals of vehicle components positions at the vehicle telematics unit and computer readable code for determining whether the vehicle components positions are in an unsecured status position. The computer usable medium also includes computer readable code for sending a notification signal based on the determination from the vehicle telematics unit to the key fob and computer readable code for activating the status indicator of the key fob based on the notification.

Another aspect of the invention provides a system for providing vehicle security status from a vehicle telematics unit to a key fob. The system includes means for receiving sensor signals of vehicle components positions at the vehicle telematics unit and means for determining whether the vehicle components positions are in an unsecured status position. The system further includes means for sending a notification signal based on the determination from the vehicle telematics unit to the key fob and means for activating the status indicator of the key fob based on the notification.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 shows an illustration of one embodiment of a wireless key system for communicating vehicle security status from a vehicle to a key fob, in accordance with the current invention;

FIG. 2 illustrates one embodiment of a wireless key fob for a mobile vehicle, in accordance with the current invention; and

FIG. 3 is a flow diagram of one embodiment of a method for communicating vehicle security status from a vehicle to a key fob, in accordance with the current invention.

### DETAILED DESCRIPTION OF THE PRESENTLY PREFERRED EMBODIMENTS

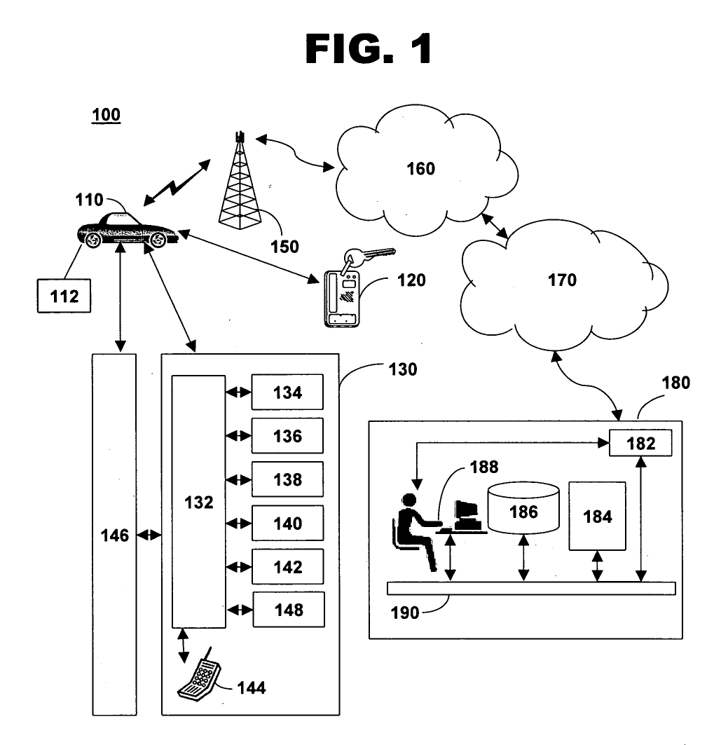

FIG. 1 shows an illustration of one embodiment of a wireless key system for communicating vehicle security status from a vehicle to a key fob using an embedded telematics unit, in accordance with the present invention at 100. The wireless key system and method employ wireless radio-frequency communications between the key fob and a telematics unit installed in a vehicle to perform various services and functions. The invention leverages the infrastructure of a vehicle communication network and telematics unit, enabling functions to be performed directly in the vehicle. Other functions may be initiated and performed by using a wireless carrier or telematics service call center, which is connected wirelessly to the telematics unit.

Wireless key system 100 includes a mobile vehicle 110, a key fob 120, a communications controller or telematics unit 130, one or more wireless carrier systems 150, one or more communication networks 160, one or more land networks 170, and one or more call centers 180. Mobile vehicle 110 is equipped with suitable hardware and software for transmitting and receiving voice and data communications.

Mobile vehicle 110 also includes a plurality of position sensors 112. Position sensors 112 are placed in the vehicle to determine the status of various vehicle components. They may be placed to determine whether a vehicle component is open or closed, or on or off. In one embodiment, vehicle 110 includes position sensors located to determine whether a widow is open or closed. In other embodiments, position sensors may be placed to determine whether the trunk, hood, doors and/or sunroof are open or closed. Still other position sensors may be placed to determine whether the doors are locked or unlocked. In another embodiment, a position sensor 112 is placed to determine the position of the headlight switch, i.e., whether the switch is in the headlights on or headlights off position. Other position sensors may be included that determine the position of the switches for the interior lights and running lights. Those with skill in the art will recognize that these are just a few of the many other components that may have an associated position sensor.

Key fob 120 is wirelessly connected to a telematics unit 130 of mobile vehicle 110. Telematics unit 130 includes a digital signal processor (DSP) 132 connected to a wireless modem 134, a global positioning system (GPS) unit 136, an in-vehicle memory 138, a microphone 140, one or more speakers 142, and an embedded or in-vehicle mobile phone 144. DSP 132 may also be referred to as a microcontroller, controller, host processor, ASIC, or vehicle communications processor. GPS unit 136 provides longitude and latitude coordinates of the vehicle. In-vehicle mobile phone 144 may be an analog, digital, dual-mode, dual-band, multi-mode or multi-band cellular phone. Telematics unit 130 may also include a proximity sensor 148. Proximity sensor 148 monitors the location of the key fob in relation to the vehicle. In one embodiment, proximity sensor 148 is activated upon the removal of the key from the vehicle ignition. Proximity sensor 148 then determines when the key fob moves beyond a predetermined distance from the vehicle. In one embodiment, the predetermined distance is ten yards. In one embodiment, an alarm signal is sent to the key fob 120 via the telematics unit 130 immediately upon the determination that the vehicle is not secured and that the key fob 120 has moved beyond the predetermined distance from the vehicle.

DSP 132 executes various computer programs that control programming and operational modes of electronic and mechanical systems within mobile vehicle 110. DSP 132 controls communications between telematics unit 130, wireless carrier 150, and call center 180. A voice-recognition application may be installed in mobile vehicle 110 and may translate human voice input through microphone 140 into digital signals. The voice-recognition application may be located in DSP 132 or other on-board electronic equipment such as a radio or electronic controller. DSP 132 may generate and accept digital signals transmitted between key fob 120 and telematics unit 130. In one embodiment, these digital signals provide status indications from position sensors located within vehicle 110.

Mobile vehicle 110 via a vehicle communication network 146 sends signals to various pieces of equipment and systems within mobile vehicle 110 to perform various functions such as unlocking a door, opening the trunk, setting personal comfort settings, and calling from telematics unit 130. Position sensors 112 send signals to telematics unit 130 via vehicle communication network 146.

Mobile vehicle 110 via telematics unit 130 sends and receives radio transmissions from wireless carrier system 150. Wireless carrier system 150 comprises any suitable system for transmitting a signal from mobile vehicle 110 to communication network 160.

Communication network 160 comprises services from one or more mobile telephone switching offices and wireless networks. Communication network 160 connects wireless carrier system 150 to land network 170. Communication network 160 may be any suitable system or collection of systems for connecting wireless carrier system 150 to mobile vehicle 110 and land network 170.

Land network 170 may be a public-switched telephone network (PSTN) or an Internet protocol (IP) network. Land network 170 may comprise a wired network, an optical network, a fiber network, another wireless network, or any combination thereof. Land network 170 may be connected to one or more landline telephones. Land network 170 connects communication network 160 to call center 180. Communication network 160 and land network 170 connects wireless carrier system 150 to a communication node or call center 180.

Call center 180 contains one or more voice and data switches 182, one or more communication services managers 184, one or more communication services databases 186, one or more communication services advisors 188, and one or more network systems 190.

Call center 180 provides a plurality of functions. Call center 180 comprises a location where many calls are received and serviced at the same time, or where many calls are sent at the same time. The call center 180 further comprises a telematics call center, facilitating communications to and from telematics unit 130 in mobile vehicle 110. The call center may be a voice call center, providing verbal communications between a live advisor in the call center and a subscriber in a mobile vehicle, a virtual call center having virtual advisors or a combination of both. The call center may contain each of these functions.

Call center 180 contains one or more voice and data switches 182. Switch 182 connects land network 170 to call center 180. Switch 182 transmits voice or data transmissions from call center 180. Switch 182 also receives voice or data transmissions from telematics unit 130 in mobile vehicle 110 through wireless carrier system 150, communication network 160, and land network 170. Switch 182 receives from or sends to one or more communication services managers 184 data transmissions via one or more network systems 190. Communication services manager .184 includes suitable hardware and software capable of providing requested communication services to telematics unit 130 in mobile vehicle 110. Communication services manager 184 sends data transmissions to or receives data transmissions from one or more communication services databases 186 and one or more communication services advisors 188 via network system 190. Communication services database 186 sends data transmissions to or receives data transmissions from communication services advisor 188 via network system 190. Communication services advisor 188 receives voice or data transmissions from or sends voice or data transmissions to switch 182.

Communication services manager 184 provides one or more of a variety of services, including enrollment services, navigation assistance, directory assistance, roadside assistance, business or residential assistance, information services assistance, emergency assistance, and communications assistance. Communication services manager 184 transmits data to telematics unit 130 in mobile vehicle 110 through wireless carrier system 150, communication network 160, land network 170, voice and data switch 182, and network system 190. Communication services manager 184 may store or retrieve data and information from communication services database 186. Communication services manager 184 provides requested information to communication services advisor 188.

Communication services advisor 188 may be a real advisor or a virtual advisor. A real advisor may be a human being in verbal communication with a user or subscriber in mobile vehicle 110 via telematics unit 130. A virtual advisor may be a synthesized voice interface responding to requests from telematics unit 130 in mobile vehicle 110.

Communication services advisor 188 provides services to telematics unit 130 in mobile vehicle 110. Services provided by communication services advisor 188 may include enrollment services, navigation assistance, real-time traffic advisories, directory assistance, roadside assistance, business or residential assistance, information services assistance, emergency assistance, and communications assistance. Communication services advisor 188 may communicate with telematics unit 130 in mobile vehicle 110 through wireless carrier system 150, communication network 160, and land network 170 using voice transmissions, or through communication services manager 184 and switch 182 using data transmissions. Switch 182 may select between voice transmissions and data transmissions.

Communication between telematics unit 130 and key fob 120 may use wireless networking protocols such as IEEE 802.11b and IEEE 802.15 that operate in the 2.4-GHz industrial, scientific and medical (ISM) band. IEEE 802.11b, often referred to as wireless fidelity (Wi-Fi), is a standard commonly used for communication on wireless local area networks (WLAN). Key fob 120 may also use the lower-powered technology of Bluetooth™ or the IEEE 802.15 protocol, a short-range radio standard often employed in wireless personal area networks (WPAN). Bluetooth™ is particularly suited for wireless connections within 10 meters. WiFi and Bluetooth™ technology allow communication between devices located within approximately 10 to 100 meters of one another.

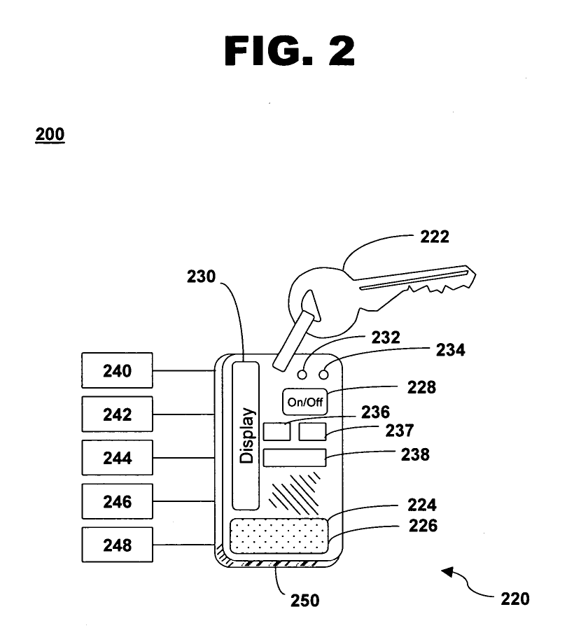

FIG. 2 is an illustration of one embodiment of a wireless key fob for receiving security status from a mobile vehicle, in accordance with the present invention at 200. Key fob 220 is a small hardware device with a size comparable to that of cellular phones or pagers, for example, and dimensions for comfortably fitting into a purse, on a belt, or in a pocket. The key fob may control basic services such as unlocking doors, as well as facilitate higher end services such as defining programmable steering wheel buttons, seat positions and radio stations. The telematics unit in the vehicle may access information stored in the key fob. In one embodiment, key fob 220 includes memory, a controller, a display, LEDs, a speaker and an on/off button. In other embodiments, key fob 220 further includes other user interface mechanisms, and increasingly powerful wireless communication devices and voice-recognition capabilities.

Key fob 220 may have built-in authentication mechanisms to communicate with the telematics unit and vehicle-area network in a specific vehicle. Each key fob 220 may have a unique identifier that the vehicle system uses to authorize vehicle operation. Key fob 220 may have an intelligent key containing information about the owner and user preferences, such as favorite radio stations, seat position and temperature control settings. The mobile vehicle may have several programmed key fobs 220, one for each driver. Each key fob may have additional stored information that may include personal comfort settings, temperature settings, mirror alignments, and radio-station preferences.

When acting as a simple remote control, key fob 220 sends radio frequency signals to the telematics unit to interpret, initiate and perform the requested function. Alternatively, key fob 220 may contain a large amount of memory and processing capability to perform most of the desired functions, while the telematics unit may have only limited processing power and minimal functionality.

Key fob 220 may or may not be linked to one or more keys 222. Key fob 220 is detachable from key 222, which may be an office key, house key, or a valet key with limited functionality for turning on and off the ignition of the mobile vehicle. Key fob 220 may include a directional microphone 224, a speaker 226, an on/off switch 228, a light-emitting-diode (LED) display 230, an LED 232 such as a green LED, an LED 234 such as a red LED, buttons 236, 237, 238, a controller 240, memory 242, a transceiver 244, an antenna 246, a battery 248, and a connector 250 that provides electrical connection to a docking mechanism for recharging the battery. Key fob 220 may have a battery 248, such as a lithium ion battery, that is recharged while the key fob is docked in a recharging device. Battery 248 provides power to run microphone 224, speaker 226, LEDs 232 and 234, controller 240, memory 242, and transceiver 244. LEDs may be used as power indicators, lighted green LED 232 meaning a charged battery and red LED 234 meaning a low-charged battery. On/off button 228 may be part of the key-fob design, although buttons or digital input from a keyboard are an optional part of the key fob, because all communications to the mobile vehicle may occur through voice input and voice recognition.

Buttons 236, 237, 238 perform various remote functions as are well known in the art. For example, buttons 236, 237, 238 may be programmed to lock\unlock the doors, turn on/off an alarm, and turn on/off the lights.

LCD display 230 displays messages sent from controller 240. LCD display 230 displays text or symbols with vehicle security status information, such as, for example, lights on, door open, window open and the like. LCD display 230 may also display transmission information, processing information prompts, command options, confirmation messages from the telematics unit or any other message that might be sent from controller 240. Transceiver 244 may send analog or digital radio signals from the telematics unit and receive the same from the telematics unit via antenna 246. Audio output from the radio transmission or controller 240 may be sent out through speaker 226 or other tone generator.

Key fob 220 may transmit voice commands to the mobile vehicle in several ways depending on the equipment configuration. In one case, voice commands received by microphone 224 may be sent to transceiver 244, which then transmits the voice signals to the telematics unit of the vehicle where the signals are digitized and compared to a list of stored messages to determine the corresponding function message. Another option for a transmission path includes microphone 224 receiving analog voice commands and sending them to controller 240 to be digitized, from where translated digitized voice commands are routed to transceiver 244, which then transmits signals to the in-vehicle telematics unit to be further processed. Voice data may be transmitted, for example, using voice-over-internet-protocol (VOIP) technology.

A third alternative transmission path requires key fob 220 to do most of the information processing. The microphone 224 receives a voice command and sends it to controller 240 where it may be digitized and compared with function messages stored in memory within key fob 220 to identify its corresponding function request. The function message is then sent through transceiver 244 to the telematics unit to perform a requested function.

Key fob 220 includes controller 240 with computer applications that are optimized to control audio input and output, displays, capture speech from the vehicle operator and other operations of key fob 220. Controller 240 may initiate more complex macro-like sequences to perform a desired function.

Associated with controller 240 is a computer memory 242 such as a solid-state flash memory chip along with volatile memory. Memory 242 may store user preferences or personalized settings, as well as a list of messages that direct the mobile vehicle to perform certain functions. For example, the voice control system of key fob 220 may direct the mobile vehicle to secure the vehicle by locking the doors, turning off the lights, locking the trunk, closing the windows or closing the sunroof, and the like. The voice control system of key fob 220 may also direct the mobile vehicle to perform other tasks such as reposition the steering wheel; program steering wheel buttons; adjust seat positions; set climate controls and turn on seat heaters; set the radio or entertainment system to preferred stations; adjust firmness of the suspension; access onboard navigation; connect to an Internet-enabled cellular phone system; and arm or disarm the car alarm system.

Memory 242 may have records of vehicle sensor information, which may be used by a diagnostic application in controller 240 to compare with current sensory information sent from the in-vehicle telematics unit in order to diagnose an actual or perceived problem such as, for example, unlocked door(s) or trunk, open window(s) or sunroof and illuminated lights.

Wireless communication capability between key fob 220 and the telematics unit allows key fob 220 to exploit the capabilities of the telematics unit, which include vehicle-to-vehicle communications, vehicle-area networking, communication to a wireless telecommunication network, and communication to a telematics service call center. In addition, when the mobile vehicle is equipped with a digital radio, key fob 220 may use higher bandwidth communication. The network capability of key fob 220 may allow data transmissions into the vehicle from external wireless LANs such as a home network.

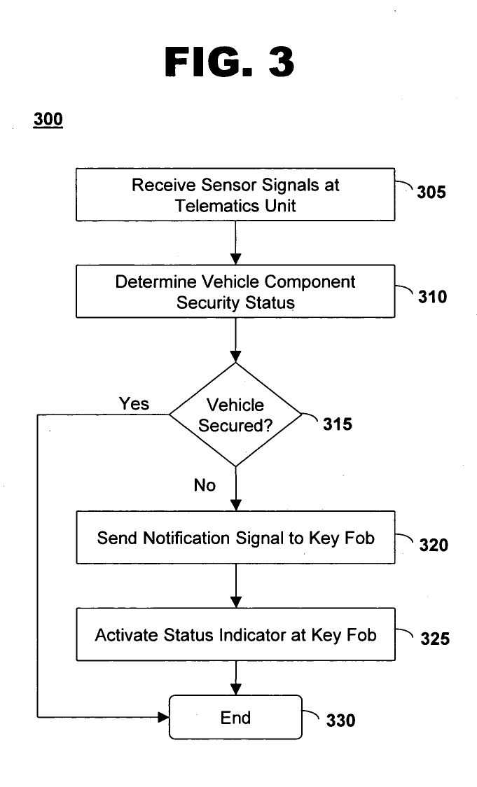

FIG. 3 is a flow diagram of one embodiment of a method for communicating vehicle security status from a vehicle to a key fob, in accordance with the present invention at 300. In an exemplary embodiment, method 300 is performed using system 100 of FIG. 1 and key fob 220 of FIG. 2. The key fob is equipped with, among other components, a controller, antenna and memory. The key fob is also equipped with a transceiver for wireless communications using a wireless communications protocol. Wireless communications are transmitted and received using any suitable analog or digital communications technologies. The wireless communications between the key fob and the telematics unit may be executed in accordance with a wireless communication protocol such as the IEEE 802.15 (Bluetooth™) or IEEE 802.11 (Wi-Fi) standards. The wireless key system may take advantage of location-based services and IEEE 802.11 hot-spot infrastructure.

One embodiment of a method for communicating vehicle security status from a vehicle to a key fob begins with receiving sensor signals at a telematics unit (Block 305). In one embodiment, sensor signals are sent to the telematics unit when the vehicle ignition is turned off. Sensor signals are sent from at least one of the plurality of component position sensors 112 located within vehicle 110. In one embodiment, for example, a position sensor 112 on a window transmits a sensor signal to the telematics unit 130 via the vehicle network 146; the signal will indicate whether the window is open or closed. In another example, the position sensor is placed on the headlight control switch to detect whether it is in the on or off position.

The DSP 132 then determines the vehicle component security status (Block 310). The security status will be based on the sensor signals received from the position sensors 112. The DSP 132 will interpret the received sensor signal and make a determination as to whether the vehicle is secured or unsecured (Block 315). The vehicle is determined to be unsecured if at least one sensor signal indicates that the vehicle component is not secured. The vehicle may be determined to be unsecured if, for example, the lights are on, at least one window is open, at least one door is unlocked and the like. A determination that the vehicle is secure indicates that each of the vehicle components are in a secure state i.e. windows closed, doors locked, lights off and the like. If it is determined that the vehicle is secure the method ends (Block 330).

If, however, it is determined that at least one of the vehicle components is not secure, a notification signal is sent to key fob 220 (Block 320). For example, a position sensor 112 may have sent a signal to the DSP 132 that indicated that the window was open. Then, upon this determination, notification signal is sent from the telematics unit 130 to the key fob 220.

The notification signal may be sent to the telematics unit upon the occurrence of a trigger event. Trigger events may be based on time or other factors such as, for example distance the key fob is from the vehicle. For example, the signal may be sent immediately upon the determination that at least one vehicle component is not secure. Alternatively, the notification signal may be sent to the key fob after a predetermined length of time has elapsed, for example, ten minutes. In one embodiment, the predetermined length of time begins when the vehicle ignition is turned off. The predetermined length of time may be for example, one to sixty minutes. Those with skill in the art will recognize that the predetermined length of time is variable and may be predetermined, or user controlled. Those with skill in the art will also recognize that more than one predetermined length of time may be utilized. For example, the system may send a notification signal two minutes after the determination of unsecured status is made and then, if the vehicle is not secured, the system may send another notification signal ten minutes later.

In another embodiment, the notification signal is sent to the key fob immediately upon the determination that the key fob has moved a predetermined distance beyond the vehicle. The proximity sensor 148 located in the telematics unit 130 determines the distance the key fob is from the vehicle. For example, the notification signal may be sent to the key fob when the vehicle driver, carrying the key fob, moves at least ten feet from the vehicle. Those with skill in the art will recognize that the predetermined distance may be any distance within the range of the communication system used between the telematics unit and the key fob. In another embodiment, the system is programmed to send the notification signal within two minutes of turning off of the vehicle ignition or the key fob moves ten yards from the vehicle, whichever occurs first.

The notification signal is received by the transceiver 244 via antenna 246 of key fob 220. The received notification signal is transmitted to the controller 240.

Controller 240 receives the notification signal indicating that the vehicle is not secure and activates a status indicator located on the key fob 220 (Block 325). In one embodiment, the status indicator is the LCD display 230. The controller 240 sends a status signal to display 230 with instructions to display the vehicle status. Continuing with the current example, the display 230 would present a message indicating that the window was open. For example, the message may be simply the text “WINDOW OPEN” displayed in as large letters as possible on the LCD display. Alternatively, the message may flash on and off in order to gain the attention of the vehicle user. In another embodiment, the status indicator is the red and/or green LEDs 232, 234 of key fob 220. Upon receipt of the notification signal, the controller may send a signal to the at least one of the LED 232, 234 causing it to flash, thereby providing a noticeable alert to the vehicle user. In another embodiment, the controller 240 sends a signal to both the display 230 and the LED 232, 234. In this embodiment the vehicle user is more likely to notice the status message. In yet another embodiment, the controller causes an alarm to sound through speaker 226 of key fob 220. The alarm may be in conjunction with a text message displayed on display 230 or may indicate to the vehicle driver that he should return to the vehicle. In still another embodiment, key fob 220 may include a vibrating component (not shown), as are well known in the art, that causes the key fob to vibrate when a status message is received from the telematics unit.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for notifying a vehicle user of an unsecured vehicle, the method comprising:
providing a key fob in wireless communication with a vehicle, the key fob including a status indicator;
receiving sensor signals of vehicle components positions at the vehicle telematics unit;
determining whether the vehicle components positions are in an unsecured status position;
sending a notification signal based on the determination from the vehicle telematics unit to the key fob; and
activating the status indicator of the key fob based on the notification.

2. The method of claim 1 further comprising:
determining whether a trigger event has occurred, wherein the notification is sent based on the trigger event determination.

3. The method of claim 2 wherein the trigger event comprises a lapse of a predetermined length of time following an ignition shut down.

4. The method of claim 3 wherein the predetermined length of time comprises a range from about two minutes to about sixty minutes.

5. The method of claim 2 further comprising:
determining the location of the key fob in relation to the vehicle based on the determination of an unsecured status of the vehicle.

6. The method of claim 5 wherein the trigger event comprises the key fob moving a predetermined distance away from the vehicle.

7. The method of claim 6 wherein sending a notification signal to the key fob comprises sending the notification signal when the key fob is about ten yards from the vehicle.

8. The method of claim 1 wherein activating the status indicator of the key fob comprises displaying a security status message on a display unit of the key fob.

9. The method of claim 1 wherein activating the status indicator of the key fob comprises activating an alarm located on the key fob.

10. The method of claim 1 wherein activating the status indicator of the key fob comprises illuminating at least one LED.

11. A computer usable medium including computer readable code for notifying a vehicle user of an unsecured vehicle, the computer usable medium comprising:
computer readable code for receiving sensor signals of vehicle components positions at the vehicle telematics unit;
computer readable code for determining whether the vehicle components positions are in an unsecured status position;
computer readable code for sending a notification signal based on the determination from the vehicle telematics unit to the key fob; and
computer readable code for activating the status indicator of the key fob based on the notification.

12. The computer usable medium of claim 11 further comprising:
computer readable code for determining whether a trigger event has occurred, wherein the notification is sent based on the trigger event determination.

13. The computer usable medium of claim 11 further comprising:
computer readable code for displaying a security status message on a display unit of the key fob.

14. The computer usable medium of claim 11 further comprising:
computer readable code for activating an alarm located on the key fob.

15. The computer usable medium of claim 11 further comprising:
computer readable code for determining the location of the key fob in relation to the vehicle based on the determination of an unsecured status of the vehicle.

16. A system for notifying a vehicle user of an unsecured vehicle, the system comprising:
means for receiving sensor signals of vehicle components positions at the vehicle telematics unit;
means for determining whether the vehicle components positions are in an unsecured status position;
means for sending a notification signal based on the determination from the vehicle telematics unit to the key fob; and
means for activating the status indicator of the key fob based on the notification.

17. The system of claim 16 further comprising:
means for determining whether a trigger event has occurred, wherein the notification is sent based on the trigger event determination.

18. The system of clam 16 further comprising:
means for determining the location of the key fob in relation to the vehicle.

19. The system of claim 16 wherein the status indicator is at least one of a LCD display, a LED, and an alarm.
